(19) United States
(12) Patent Application Publication
(10) Pub. No.: US 2014/0334050 A1
(43) Pub. Date: Nov. 13, 2014

(54) PASSIVE ARC SUPPRESSOR

(71) Applicant: Reinhold Henke, Plymouth, MN (US)

(72) Inventor: Reinhold Henke, Plymouth, MN (US)

(21) Appl. No.: 14/272,032

(22) Filed: May 7, 2014

Related U.S. Application Data
(60) Provisional application No. 61/821,074, filed on May 8, 2013.

(51) Int. Cl. H02H 1/00

(52) U.S. Cl. CPC H02H 1/0015
USPC 361/91.5; 361/91.1

(57) ABSTRACT

At least one of an electrical circuit, and arc suppression device, and an arc suppressor includes a pair of terminals, an event detection element, and a non-linear current shunt element in series with the event detection element.

### PRIORITY

This application claims the benefit of priority to U.S. Provisional Application No. 61/821,074, “PASSIVE ARC SUPPRESSOR”, filed May 8, 2013, which is incorporated by reference herein in its entirety.

### TECHNICAL FIELD

The present subject matter relates generally to electrical current arc suppression, such as arc suppression for electrical contacts, electrodes, and connectors.

### BACKGROUND

Electrical arcing may have a deleterious effect on the electrical surfaces of electrical contacts (such as those found in contactors, relays and switches), electrodes (such as those found in electrical sputtering chambers, plasma chambers, and vacuum chambers), and connectors (such as those found in electrical wiring harnesses, control panels & machinery). Over time, arcing can degrade and ultimately destroy the contact, electrode, and connector surface, and can result in premature component failure, lower quality, poor performance, and relatively frequent and costly preventative maintenance needs. Arcing in contacts, electrodes, connectors, and the like can also result in the generation of electromagnetic interference (EMI) emissions. Additionally, the degradation and destruction of the contacts, electrodes and connectors can cause significant air pollution, including, but not limited to ozone, carbon dioxide, and particulate matter.

Electrical arcing can occur both in alternating current (AC) power, in direct current (DC) power, or in a combination thereof. Electrical arcing in the electric power generation, distribution, and use is an issue that has been known for over one hundred years.

### DESCRIPTION OF THE DRAWINGS

FIGS. 1A-1H depict passive arc suppressors, in example embodiments.

FIG. 2 depicts a block diagram illustrating the connection of a passive arc suppressor across a pair of contacts, in an example embodiment.

FIG. 3 depicts a block diagram illustrating the connection of a passive arc suppressor across a pair of electrodes, in an example embodiment.

FIG. 4 depicts a block diagram illustrating the connection of a passive arc suppressor across a pair of connectors, in an example embodiment.

FIGS. 5A-5C depict a mechanical outline drawing of a front, side, and top view, respectively, of a passive arc suppressor housing enclosing a passive arc suppressor, in an example embodiment.

FIG. 6 depicts a oscillogram of an DC power waveform without a passive arc suppressor connected across a pair of contacts, in an example embodiment.

FIG. 7 depicts a oscillogram of an DC power waveform with a passive arc suppressor connected across a pair of contacts, in an example embodiment.

FIG. 8 depicts a oscillogram of an AC power waveform without a passive arc suppressor connected across a pair of contacts, in an example embodiment.

FIG. 9 depicts an oscillogram of an AC power waveform with a passive arc suppressor connected across a pair of contacts, in an example embodiment.

FIG. 10 depicts a flowchart for making at least one of an electrical circuit, an arc suppressor, and/or an arc suppression device, in an example embodiment.

### DETAILED DESCRIPTION

Circuits that are known in the art for arc suppression are conventionally either of little to no effectivity or are comparatively complex, component-intensive, and/or expensive. Such complex arc suppressors may include active components that consume power in their own right and that may occupy relatively large amounts of physical space. Given the impact of arcs on electrical connects, electromagnetic emissions, and the like, the continued reliance in the art on arc suppressors of limited effectiveness or that include complex active components may represent an ongoing market failure and may create a need for a simple, effective arc suppression circuit.

A passive arc suppressor has been developed that can interrupt electrical current arcing. The passive arc suppressor utilizes only a relatively few passive components and does not rely on active components, such as components that rely for their operation on an external power source. The passive arc suppressor may prevent an arc from forming or substantially mitigate the effects of the arc after the arc has begun to form. These effects include, but are not limited to, contact, electrode and connector surface deterioration, air pollution, and electromagnetic emissions.

Because contacts, electrodes and connectors that are exposed to arcs are subject to degradation from the arc, conventionally such contacts may be “overbuilt” to allow for some degradation over time and still function. However, such “overbuilding” may increase the cost of such contacts. Limiting the destructiveness of the arc may also allow a significant reduction in the construction of contact, electrode and connector weight and size requirements that have been designed to offset arcing damage. In various examples, the passive arc suppressor can permit contacts, electrodes and connectors to be constructed relatively smaller and of relatively less exotic material than contacts, electrodes and connectors that are either unprotected from arcs or which are protected by less-effective alternative arc suppression technologies, owing to the reduced potential for damage to the contacts, electrodes and connectors from arcing in contrast to alternative arc suppression technologies.

Limiting the destructiveness of the arc may also reduce pollution caused by both the material destruction and the high arc energy cracking of the chemical bonds in the gases of the atmosphere around the contacts, electrodes, or connections. Suppressing the arc may also significantly reduce electromagnetic emissions that may be generated by the arc itself.

The passive arc suppressor in general may be contact agnostic, connector agnostic, electrode agnostic, hook-up agnostic, load agnostic, polarity agnostic, current agnostic, voltage agnostic, power agnostic, and device agnostic. Various particular examples of the passive arc suppressor may include components of selectable characteristics for particular uses. For instance, while various general architectures may be utilized between and among various circumstances, component values may be selectable given the particulars of individual circumstances.

In various examples, the passive arc suppressor event detection element indicates contact separation and/or arc ignition, and may be based on indications of contact separation and arc ignition that are relatively small in comparison with what may be detectable by alternative arc suppression technologies. In addition, the passive arc suppressor non-linear current shunt element may have a resistance that is lower than the arc resistance upon the ignition of the arc. In various examples, the passive arc suppressor can generate a signal indicative of a suppressed arc.

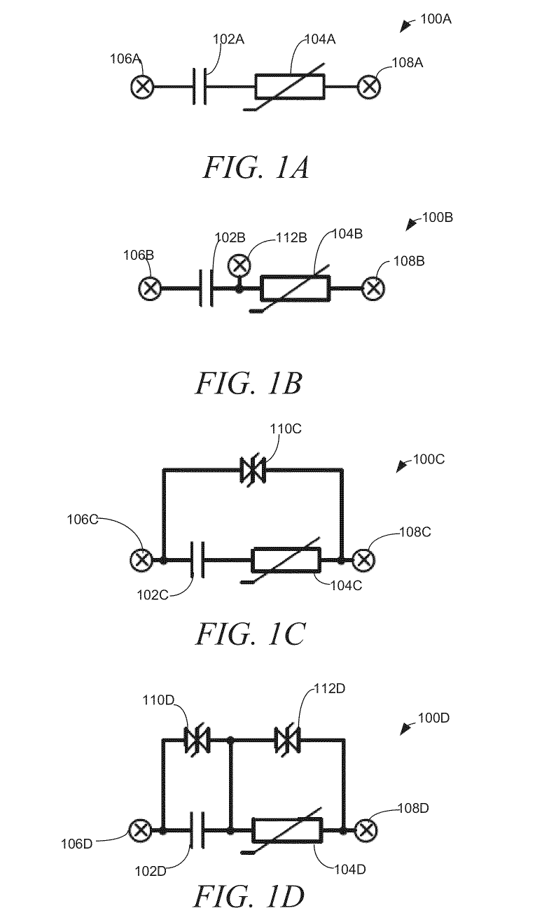

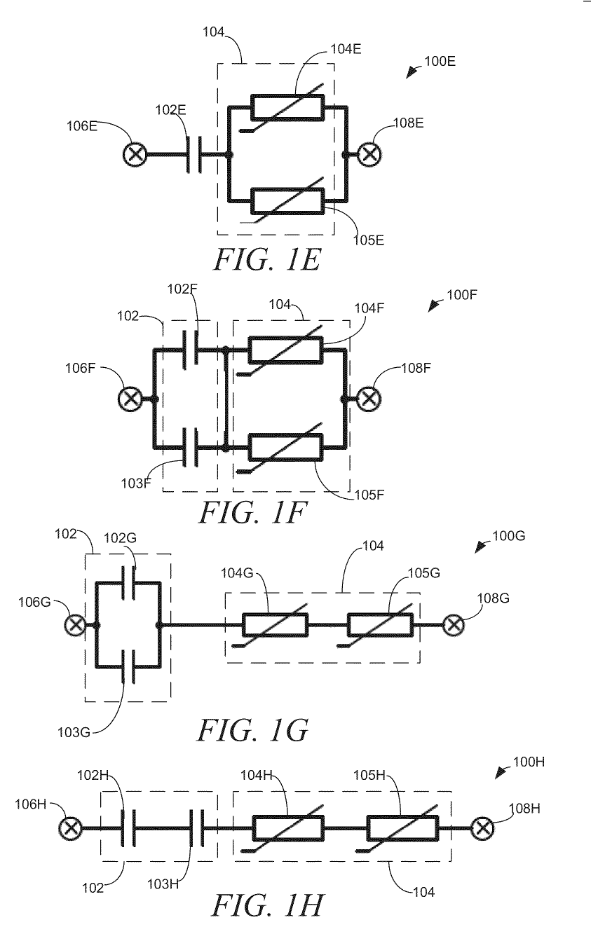

FIG. 1A depicts a passive arc suppressor 100A including an event detection element (EDE) 102A, a non-linear current shunt element (CSE) 104A and wiring terminals 106A, 108A. In various examples, the passive arc suppressor 100A optionally may be understood to include or not include the wiring terminals 106A, 108A.

In various examples, the event detection element 102A and the non-linear current shunt element 104A may be or may include any of a variety of components. The event detection elements 102 and the current shunt elements 104 disclosed herein may be scaled according to component ratings such as, but not limited to, positive temperature coefficient (PTC) characteristics, resistance, capacitance, voltage, current, tolerance, power, and temperature de-rating, to construct specific arc suppressors. In certain examples, the event detection element 102A has capacitive coupling properties, and may be comprised of a solid dielectric material, a liquid dielectric material, or a gaseous dielectric material. In certain examples, the non-linear current shunt element 104A has resistive PTC properties, and may be comprised of solid PTC material, a liquid PTC material, or a gaseous PTC material.

In various examples, the event detection element 102A, or any of the event detection elements 102 disclosed herein, is any differentiating element that may detect a steady state and a particular change in the steady state that is an event indicative of an arc. The event detection element 10A2 may be or may include a solid dielectric material of either inorganic matter, such as a ceramic capacitor, or organic matter, such as a film capacitor. In an example, the event detection element 102A including a liquid dielectric material may be of conventional or liquid crystal, such as an electrolytic capacitor. In an example, an event detection element 102A including a gaseous dielectric material may be or include a pressurized or non-pressurized elemental gas, compound molecule, or gas mixture.

In various examples, a non-linear current shunt element 104A comprised of a solid resistive PTC material may be either inorganic matter, such as a Thyrite arrestor or PTC Thermistor, or organic matter, such as a resettable fuse. In various examples, a non-linear current shunt element 104A including a liquid resistive PTC material may be a conventional or liquid crystal, such as an oil, gel, or electrolyte. In various examples, a non-linear current shunt element 104A including a gaseous resistive PTC material may be a pressurized or non-pressurized elemental gas, compound molecule, or gas mixture.

The various components and component types disclosed herein for the event detection element 102A and the non-linear current shunt element 104 may be combined in various combinations to form the event detection element 102A and the current shunt element 104A as shown in FIG. 1A. While FIGS. 1B-1I depict particular configurations of passive arc suppressors (collective reference numeral 100) with particular components, it is to be understood that the components of FIGS. 1B-1I may include or have substituted the various components and component types for the event detection element (collectively reference numeral 102) and the current shunt element (collectively reference numeral 104) as disclosed herein. Moreover, such example passive arc suppressors 100 are not exhaustive of the potential configurations of such passive arc suppressors and it is to be understood by one of ordinary skill in the art that various passive arc suppressor 100 configurations may be implemented according to the principles described and illustrated herein.

The passive arc suppressors 100 may be configured for a variety of specifications. In various examples, the passive arc suppressors 100 are configured for high voltage and high current. In various examples, the passive arc suppressors are configured to low voltage, low current. It is noted and emphasized that the various event detection elements may collectively be referred to as event detection elements 102 and that the current shunt elements may collective be referred to as current shunt elements 104. Any description of the components of a particular event detection element 102 and/or a current shunt element 104 may be generally applicable to any or all of the event detection elements 102 and/or current shunt elements 104 disclosed herein. Thus, particular components that are described with respect to one event detection element 102 and/or current shunt element may be used in any or all of the specifically-illustrated event detection elements 102 and/or current shunt elements 104.

In an example, the non-linear current shunt element 104 is or includes a positive temperature coefficient (PTC) device. The PTC device is a temperature dependent non-linear resistor having a resistance that increases with increasing temperature. When current through a PTC device goes up, the heat dissipation within the PTC device may rise. When the heat dissipation within the PTC device rises, its resistance may rise as well. This PTC characteristic is non-linear resulting in a specific current (heat) at which the internal PTC resistance changes dramatically to high resistance. This effect of the PTC device may protect electronic components from over current. The PTC device may, in effect, be a thermal resistor and more specifically a resettable fusing element, e.g., when the over current condition is removed, the temperature of the PTC lowers and congruently its resistance lowers.

The PTC may be configured to protect the passive arc suppressor 100 generally and a circuit into which the passive arc suppressor 100 is inserted from electrical overstress and potential resultant damage or degradation. The PTC may act as an inherent self-preserving mechanism to or of the passive arc suppressor 100, such as by protecting the event detection element 102 from electrical overstress and potential resultant damage or degradation. In an example, the event detection element 102 is a 1 uF, 100V, 10%, X7T, MLCC capacitor and the non-linear current shunt element 104 is a 60V, 40 A, PTC resettable fuse.

As soon as an arc is about to ignite, a fast change in voltage in a very short time interval (dV/dt) appears across the passive arc suppressor 100. The fast change in voltage causes a fast change in current to flow through the event detection element 102 and through the non-linear current shunt element 104. In various examples, the event detection element 102 may not present a significant resistance to a fast change in current.

The non-linear current shunt element 104 may present a resistance that is significantly lower than the arc ignition resistance. This is one reason of why a snubber circuit consisting of a resistor (e.g., from approximately ten (10) Ohms to one thousand (1,000) Ohms) as a non-linear current shunt element that is significantly higher than the arc resistance may not suppress resulting current arcing.

An approximate arc ignition resistance may be calculated as the ratio of an arc voltage of the material that comprises the terminals 106, 108 to a specific load current at the time of arc ignition. In an example, depending on the specific alloy material used in the contacts, electrodes or connectors, the arc voltage may range between approximately nine (9) and fifteen (15) Volts. For common contact materials, an arc ignition voltage of approximately twelve (12) Volts may be typical. Thus, a current of one (1) Ampere at arc ignition results in an initial arc resistance of twelve (12) Ohms, while a current of ten (10) Amperes at arc ignition results in an initial arc resistance of 1.2 Ohms, and so forth.

In an example, a solid matter PTC non-linear current shunt element 104 is a resettable fuse, which is constructed of a polymeric positive temperature coefficient (PPTC) material. In such an example, an electrical arc develops and ignites when electrical power to the terminals 106, 108 is interrupted. Because of thermionic heating of the terminals 106, 108, due to the high current density in the current constriction or hot spot, terminals 106, 108, such as contacts, electrodes, or connectors, matter may transition explosively through all four matter phases from solid to liquid to gas to plasma, such as within several nanoseconds.

FIG. 1B depicts a passive arc suppressor 100B as a low voltage, low current passive arc suppressor including a capacitor 102B as the event detection element 102, a resettable fuse 104B as the current shunt element 104, two wiring terminals 106B, 108B, and a monitor terminal 110B. FIG. 1C depicts a passive arc suppressor 100C as an overvoltage protected, low voltage, low current passive arc suppressor including a capacitor 102C as the event detection element 102, a resettable fuse 104C as the current shunt element 104, two wiring terminals 106C, 108C, and an over voltage suppressor 110C. FIG. 1D depicts a passive arc suppressor 100D as an overvoltage protected low voltage, low current passive arc suppressor including a capacitor 102D as the event detection element 102, a resettable fuse 104D as the current shunt element 104, two wiring terminals 106D, 108D, and two over voltage suppressors 110D, 112D.

FIG. 1E depicts a passive arc suppressor 100E as a low voltage, high current passive arc suppressor including a capacitor 102E as the event detection element 102, two resettable fuses 104E, 105E that combine to form the current shunt element 104, and two wiring terminals 106E, 108E. FIG. 1F depicts a passive arc suppressor 100F as a low voltage, high current passive arc suppressor including two capacitors 102F, 103F that combine to form the event detection element 102, two resettable fuses 104F, 105F that combine to form the current shunt element 104, and two wiring terminals 106F, 108F. FIG. 1G depicts a passive arc suppressor 100 as a high voltage, low current passive arc suppressor including two capacitors 102G, 103G that combine to form the event detection element 102, two resettable fuses 104G, 105G that combine to form the current shunt element 104, and two wiring terminals 106G, 108G. FIG. 1H depicts a passive arc suppressor 100H as a high voltage, high current passive arc suppressor including two capacitors 102H, 103H that combine to form the event detection element 102, two resettable fuses 104H, 105H that combine to form the current shunt element 104, and two wiring terminals 106H, 108H.

While in various examples the passive arc suppressor 100 is not necessarily limited only to the event detection element, the current shunt element 104, and the terminals 106, 108, in various additional examples the passive arc suppressors 100 includes only or essentially only the event detection element 102 and the current shunt element 104 in series with the terminals 106, 108 or connector-equivalent elements as disclosed herein (e.g., electrodes, contacts, and the like). In various examples, the passive arc suppressors 100 include only or essentially only the event detection element 102 and the current shunt element 104 without respect to the terminals 106, 108. In such examples, wires, traces, and/or other conductors may couple the event detection element 102 to the current shunt element 104 and, in various examples, to the terminals 106, 108. Moreover, functionally irrelevant electronic components, such as very low impedance resistors and the like, may be included to the extent that such functionally irrelevant electronic components do not materially impact the performance of the passive arc suppressor 100. But the passive arc suppressor 100 may otherwise be defined both by the components that the passive arc suppressor 100 positively includes as well as the components that the passive arc suppressor 100 does not include, i.e., the simplicity of the passive arc suppressor 100 may provide advantages in efficiency, cost, and size that may be at least partially obviated by the inclusion of additional components that do not affirmatively contribute to either the event detection element 102 and/or the current shunt element 104.

It may be contrary to standard circuits in the art to connect an event detection element 102, such as a capacitor, to a non-linear current shunt element 104, such as a resettable fuse, and then connect this construct across a set of terminals 106, 108. Snubbers, for instance, may be thought to suppress electrical arcing. In many cases snubbers fail to suppress electrical arcing especially when load currents exceed one (1) Ampere and the snubber resistor is greater than the arc resistance at the instant of arc ignition. The passive arc suppressors 100 disclosed herein may cure such defects.

In various examples, the passive arc suppressor does not have a significant current pass through on power-up. In various examples, the passive arc suppressor is of low leakage in that it does not generate significantly more leakage current than an RC snubber known in the art may generate in the same application. In various examples, the passive arc suppressor provides relatively high voltage isolation.

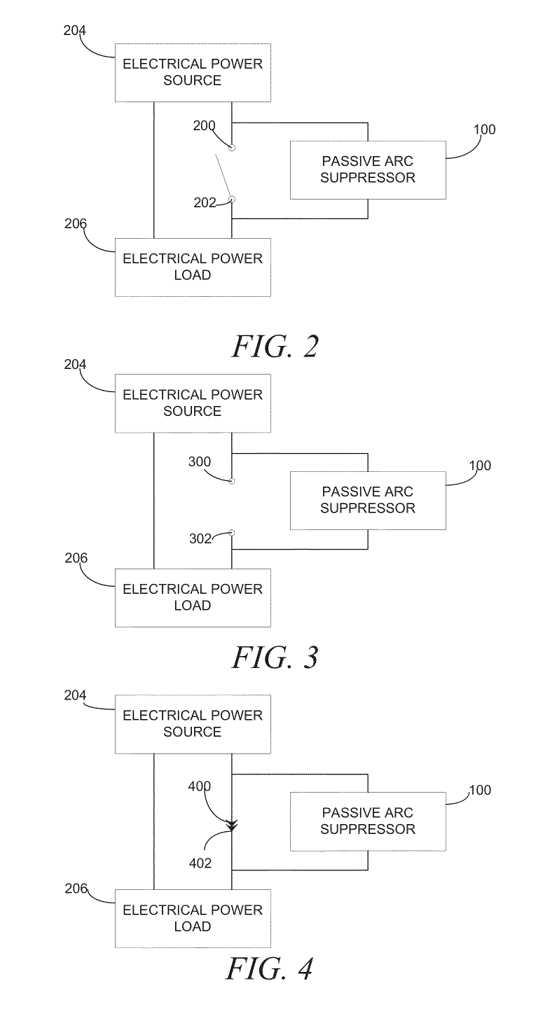

FIG. 2 depicts a block diagram illustrating the connection of a passive arc suppressor 100 across a pair of contacts 200, 202 coupled to an electrical power source 204 and an electrical power load 206. The contacts 202, 204 may be coupled to the terminals 106, 108, respectively. The pair of contacts 200, 202 may or may not, in various examples, include a mechanical throw and/or a relay as known in the art, and may be electrically or mechanically controlled. FIG. 3 depicts a block diagram illustrating the connection of a passive arc suppressor 100 connected across a pair of electrodes 300, 302 coupled to the electrical power source 204 and the electrical power load 206. The electrodes 300, 302 may be coupled to the terminals 106, 108, respectively. FIG. 4 depicts a block diagram illustrating the connection of a passive arc suppressor 100 connected across a pair of connectors 400, 402 coupled to the electrical power source 204 and the electrical power load 206. The connectors 400, 402 may be coupled to the terminals 106, 108, respectively.

It is to be noted and emphasized that the systems of FIGS. 2-4 may or may not include the electrical power source 204 and the electrical power load 206. Thus, FIGS. 2-4 are to be understood to optionally include the electrical power source 204 and the electrical power load 206, and that examples of the system disclosed herein are contemplated that do not include the electrical power source 204 and/or the electrical power load 206. In various examples, the passive arc suppressors 100 can operate on alternating current (AC), on direct current (DC), or on direct and alternating current (AC/DC) simultaneously.

The passive arc suppressors 100 may generate relatively minimal heat in comparison with active arc suppressors and other alternative arc suppression technologies and may be operated in a comparatively wide range of ambient operating temperatures. In various examples, the passive arc suppressors 100 can allow contacts, electrodes and connectors to operate at a faster rate, at higher ambient temperatures, and at higher duty cycles than contemporary contacts, electrodes and connectors are designed to operate with alternative arc suppression technologies.

In an example test configuration, the electrical power source 204 is a DC electrical power source providing thirty-two (32) Volts, and the electrical power load 206 is nine (9) Ohms. In an example, a resulting load current was approximately 3.5 Amperes. Contact cycle time of the control relay may be about eight (8) times per second. DC leakage may be less than 0.1 mA. In this example, the current let through upon power turn may be negligible or effectively zero.

In such an example, the initial arc resistance at the instant of ignition may be 3.42 Ohms (12V/3.5 A). By contrast, a typical RC snubber with a capacitor of 0.1 uF and a resistor of 10 ohm may not have prevented an arc from igniting because the snubber impedance may tend to be significantly greater than the 3.42 Ohm initial arc resistance and the instant of ignition. Immediately after arc ignition, the arc resistance becomes lower. An arc may, in effect, be a negative dynamic resistor within the context of the system.

In another example, the electrical power source 204 is an AC electrical power source providing an output of twenty-four (24) Volts RMS and the electrical load 206 was nine (9) Ohms. A resulting load current was 2.6 Amperes RMS. AC Leakage may be measured in this example to be less than one (1) milliAmpere. Contact cycle time of a control relay may be about eight (8) times per second.

The time it takes to starve an arc of charge carriers may be sufficiently short to make a significant difference when comparing arc energy without arc suppression by the passive arc suppressor 100 to residual arc energy with arc suppression provided by the passive arc suppressor 100. The passive arc suppressor 100 may provide a time difference that may prevent significant contact, electrode, and connector erosion and performance degradation. Shunting the arc current from the contact, electrodes and connectors at arc ignition may starve the developing thermionic arc of charge carriers, which may be required to maintain the developing arc. The resulting arc may be extinguished or otherwise inhibited from further ignition by the passive arc suppressor 100.

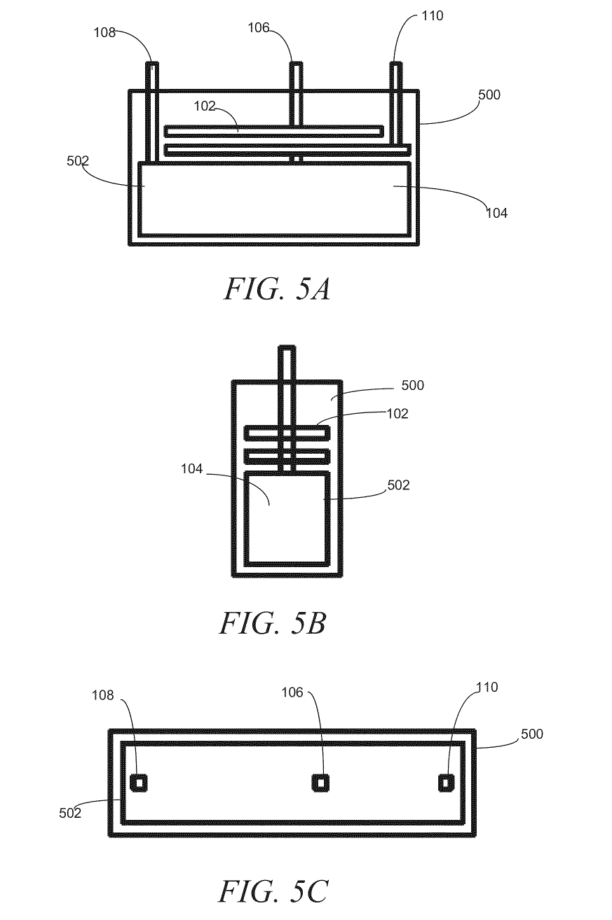

FIGS. 5A-5C depict a mechanical outline drawing of a front, side, and top view, respectively, of a passive arc suppressor housing 500 enclosing the passive arc suppressor 100. The housing encloses the event detection element 102, the non-linear current shunt element 104, a monitor terminal 110, and two wiring terminals 106, 108. The event detection element 102 may be constructed of a high voltage parallel plate capacitor. The event detection element 102 may be placed above the non-linear current shunt element 104. The non-linear current shunt element 104 may reside within a separate container 502 that is enclosed by the passive arc suppressor housing 500.

In various examples, the passive arc suppressor 100 may not require a new design structure for a different contact, electrode and connector application, a different load application, or a different power application. For example, it can be integrated into the device housing 500 to be co-located next to the contacts, electrodes and connectors it is protecting from the effects of current arcing. A passive arc suppressor 100 may extend, at least in part, the life of contacts, electrodes and connectors used to conduct either an alternating current (AC) and/or a direct current (DC) source to a load.

In various examples, the passive arc suppressor 100 may be scalable to cover a range of applications from low power to high power and/or from small size to large size. Such a range may include examples in which the passive arc suppressor 100 is miniaturizable to fit inside of relays and connectors or is large enough to address arcing in power grid transmission lines. The passive arc suppressor 100 can, in various examples, be integrated into a connector.

Examples of uses for passive arc suppressors include but are not limited to the following areas: automotive applications, such as cars, trucks, boats, utility and recreational vehicles; commercial applications, such as heaters, air-conditioners & freezers; consumer applications, such as kitchen, home & office appliances; military applications, such as manned and unmanned vehicles, waterborne vessels, submersible vessels, and aircraft; and industrial applications, such as electrostatic poling, material sputtering, plasma chambers and particle accelerators.

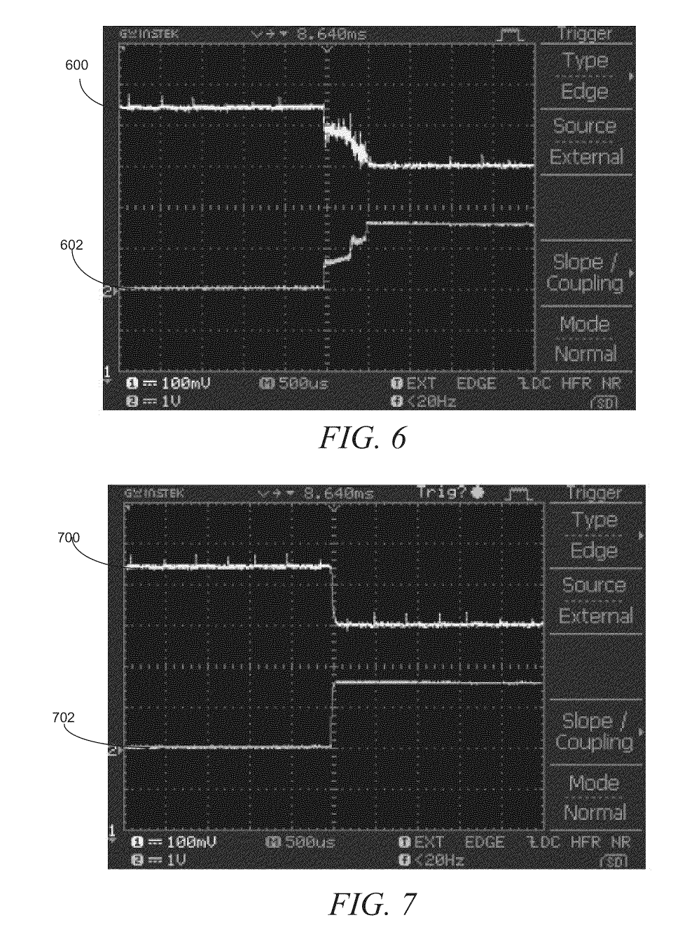

FIGS. 6, 7, 8 and 9 depict current waveforms and DC voltage waveforms as may be generated by and detected from a system with a pair of contacts. The top traces 600, 700, 800, 900 in each of FIGS. 6, 7, 8, and 9, respectively, represent the current waveform through a pair of contacts, such as the contacts 200, 202. The current waveform may be produced by measuring current using a high speed, Hall Effect current probe. The current to voltage conversion factor may be 23.7 Amperes per Volt to produce the traces. The bottom traces 602, 604, 606, 608 in FIGS. 6, 7, 8, and 9, respectively, represent the voltage waveform across the pair of contacts. The voltage waveform may be produced by measuring voltage using a high voltage, differential voltage probe. The differential to single ended voltage conversion factor may be 1/20 to produce the traces. The contact state of the contacts 200, 202 may be closed to the left of the center divide and the contact state may be open to the right of the center divide.

FIG. 6 depicts a waveform diagram illustrating an example of a contact current and voltage measurement without a passive arc suppressor 100. As soon as the pair of contacts opens during the transition from the closed to the open state an electrical arc ignites and burns. The arc burns or may burn as long as the current of highly energized charge carriers (plasma) in the widening air gap between the pair of contacts thermodynamically support the arc.

Referring to the top trace 600, during the closed state of the contact, current through the contact is at or approximately at a maximum. After the arc is extinguished, the current through the pair of contacts is at or near zero. The transition from maximum current to minimum current when the arc is not suppressed is on the order of several hundred microseconds to a few milliseconds.

Referring to the bottom trace 602, during the closed state of the contact, voltage across the contact is at or approximately at a minimum. After the arc is extinguished, the voltage across the pair of contacts is at or near maximum. The transition from minimum voltage to maximum voltage when the arc is not suppressed is on the order of several hundred microseconds to a few milliseconds.

FIG. 7 depicts a waveform diagram illustrating an example of a contact current and voltage measurement with a passive arc suppressor 100. As soon as the pair of contacts opens during the transition from the closed to the open state an arc develops, the passive arc suppressor 100 shunts the current away from the pair of contacts. The passive arc suppressor 100 resistance is lower than the initial arc resistance. The load current takes the path of least resistance, starving the developing arc of charge carriers, and thus causing the arc to extinguish.

Referring to the top trace 700, during the closed state of the contact, current through the contact is at or approximately at a maximum. After the arc is extinguished, the current through the pair of contacts is at or near zero. The transition from maximum current to minimum current when the arc is suppressed is on the order of a few microseconds.

Referring to the bottom trace 702, during the closed state of the contact, voltage across the contact is at or approximately at a minimum. After the arc is extinguished, the voltage across the pair of contacts is at or near maximum. The transition from minimum voltage to maximum voltage when the arc is suppressed is on the order of a few microseconds.

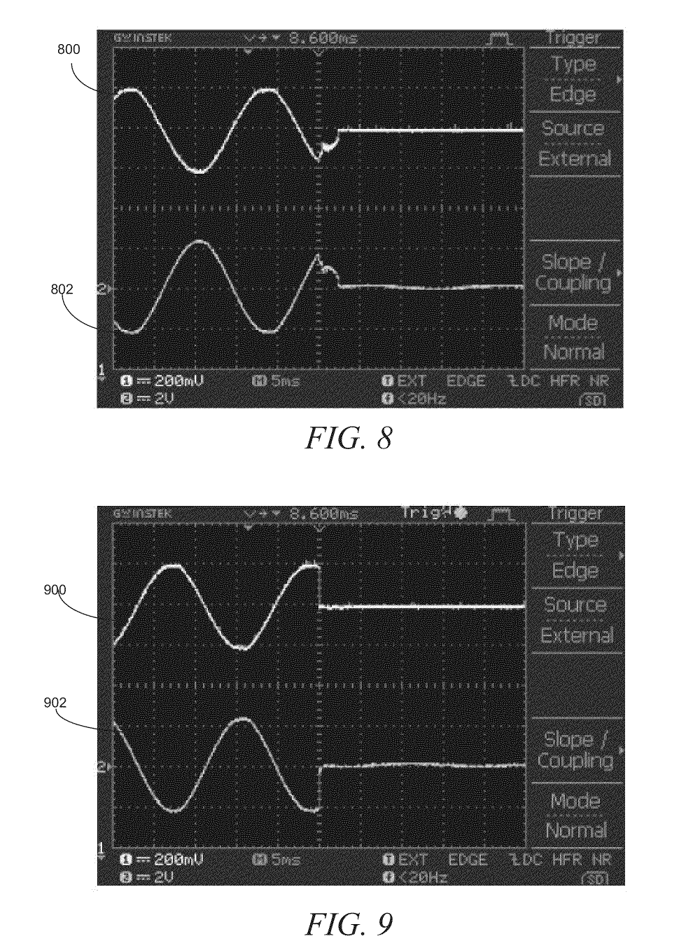

FIG. 8 depicts a waveform diagram illustrating an example of a contact current and voltage measurement without a passive arc suppressor 100. As soon as the pair of contacts opens during the transition from the closed to the open state an electrical arc ignites and burns. The arc burns as long as the current of highly energized charge carriers (plasma) in the widening air gap between the pair of contacts thermodynamically support the arc.

Referring to the top trace 800, during the closed state of the contact, current through the contact is at or approximately at a maximum. After the arc is extinguished, the current through the pair of contacts is at or near zero. The transition from maximum current to minimum current when the arc is not suppressed is on the order of a few milliseconds.

Referring to the bottom trace 802, during the closed state of the contact, voltage across the contact is at or approximately at a minimum. After the arc is extinguished, the voltage across the pair of contacts is at or near maximum. The transition from minimum voltage to maximum voltage when the arc is not suppressed is on the order of a few milliseconds.

FIG. 9 depicts a waveform diagram illustrating an example of a contact current and voltage measurement with a passive arc suppressor 100. As soon as the pair of contacts opens during the transition from the closed to the open state an arc develops, the passive arc suppressor 100 shunts the current away from the pair of contacts. The passive arc suppressor 100 resistance is lower than the initial arc resistance. The load current takes the path of least resistance, starving the developing arc of charge carriers, and thus causing the arc to extinguish.

Referring to the top trace 900, during the closed state of the contact, current through the contact is at or approximately at a maximum. After the arc is extinguished, the current through the pair of contacts is at or near zero. The transition from maximum current to minimum current when the arc is suppressed is on the order of a few microseconds.

Referring to the bottom trace 902, during the closed state of the contact, voltage across the contact is at or approximately at a minimum. After the arc is extinguished, the voltage across the pair of contacts is at or near maximum. The transition from minimum voltage to maximum voltage when the arc is suppressed is the order of a few microseconds.

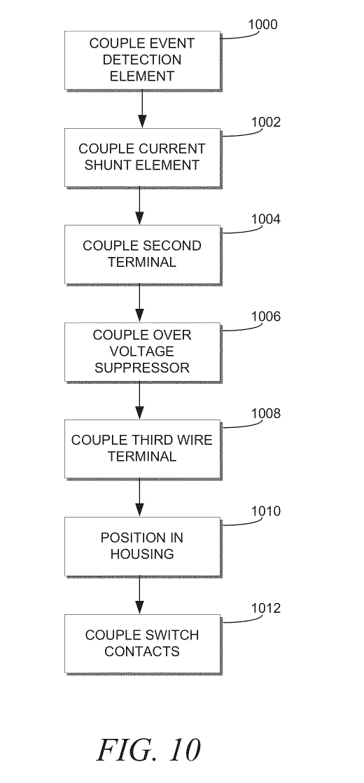

FIG. 10 is a flowchart for making at least one of an electrical circuit, an arc suppressor, and/or an arc suppression device.

At 1000, an event detection element is coupled to a first one terminal of a pair of terminals. In an example, the event detection element is coupled with a connection. In an example, the connection is a direct connection. In an example, the direct connection involves no intervening components between the event detection element and the first one of the pair of terminals. In an example, the event detection element comprises a capacitor.

At 1002, a non-linear current shunt element is coupled is series with the event detection element. In an example, the connection is a direct connection. In an example, the non-linear current shunt element comprises a fuse. In an example, the non-linear current shunt element is comprised of at least one of a solid positive temperature coefficient (PTC) material, a liquid PTC material, and a gaseous PTC material. In an example, the non-linear current shunt element is a resettable fusing element.

At 1004, a second one of the pair of terminals is coupled to the non-linear current shunt element. In an example, the connection is a direct connection.

At 1006, an over voltage suppressor coupled between the wire terminals and coupled in parallel with at least one of the event detection element and the current shunt element. In an example, the over voltage suppressor comprises a transient-voltage-suppression diode. In an example, the over voltage suppressor comprises a first element in parallel with the event detection element and in series with the current shunt element and a second element in parallel with the current shunt element and in series with the event detection element.

At 1008, a third wire terminal is coupled between the event detection element and the current shunt element. In an example, an electric potential of the third wire terminal is indicative of at least one of an arc ignition, contact separation, and a suppressed arc.

At 1010, the pair of terminals is positioned on the housing and the event detection element, and the non-linear current shunt element is positioned, at least in part, within the housing.

At 1012, the pair of wire terminals are coupled to at least one of a corresponding pair of switch contacts, a corresponding pair of electrodes, and a corresponding pair of connectors.

### EXAMPLES

In Example 1, at least one of an electrical circuit, and arc suppression device, and an arc suppressor includes a pair of terminals, an event detection element, and a non-linear current shunt element in series with the event detection element.

In Example 2, the device of Example 1 optionally further includes that the non-linear current shunt element is comprised of at least one of a solid positive temperature coefficient (PTC) material, a liquid PTC material, and a gaseous PTC material.

In Example 3, the device of any one or more of Examples 1 and 2 optionally further includes that the non-linear current shunt element is a resettable fusing element.

In Example 4, the device of any one or more of Examples 1-3 optionally further includes that, upon an ignition of an arc in parallel with the arc suppressor, the non-linear current shunt element has a resistance lower than an arc ignition resistance of the arc.

In Example 5, the device of any one or more of Examples 1-4 optionally further includes that the event detection element comprises a capacitor.

In Example 6, the device of any one or more of Examples 1-5 optionally further includes an over voltage suppressor coupled between the wire terminals and coupled in parallel with at least one of the event detection element and the current shunt element.

In Example 7, the device of any one or more of Examples 1-6 optionally further includes that the over voltage suppressor comprises a transient-voltage-suppression diode.

In Example 8, the device of any one or more of Examples 1-7 optionally further includes that the over voltage suppressor comprises a first element in parallel with the event detection element and in series with the current shunt element and a second element in parallel with the current shunt element and in series with the event detection element.

In Example 9, the device of any one or more of Examples 1-8 optionally further includes a third wire terminal coupled between the event detection element and the current shunt element.

In Example 10, the device of any one or more of Examples 1-9 optionally further includes that an electric potential of the third wire terminal is indicative of at least one of an arc ignition, contact separation, and a suppressed arc.

In Example 11, the device of any one or more of Examples 1-10 optionally further includes that the pair of wire terminals are coupled to at least one of a corresponding pair of switch contacts, a corresponding pair of electrodes, and a corresponding pair of connectors.

In Example 12, the device of any one or more of Examples 1-11 optionally further includes that the event detection element is directly coupled to a first one of the pair of wire terminals, and wherein the current shunt element is directly coupled to a second one of the pair of wire terminals, and wherein the event detection element is directly coupled to the current shunt element.

In Example 13, the device of any one or more of Examples 1-12 optionally further includes a housing, the pair of terminals positioned on the housing, the event detection element and the a non-linear current shunt element in series with the event detection element being positioned within the housing.

In Example 14, the device of any one or more of Examples 1-13 optionally further includes that the third terminal is positioned on the housing.

In Example 15, a method of making at least one of an electrical circuit, and arc suppression device, and an arc suppressor includes coupling an event detection element to a first one terminal of a pair of terminals, coupling a non-linear current shunt element is in series with the event detection element, and coupling a second one of the pair of terminals to the non-linear current shunt element.

In Example 16, the method of Example 15 optionally further includes that the non-linear current shunt element is comprised of at least one of a solid positive temperature coefficient (PTC) material, a liquid PTC material, and a gaseous PTC material.

In Example 17, the method of any one or more of Examples 15 and 16 optionally further includes that the non-linear current shunt element is a resettable fusing element.

In Example 18, the method of any one or more of Examples 15-17 optionally further includes that, upon an ignition of an arc in parallel with the arc suppressor, the non-linear current shunt element has a resistance lower than an arc ignition resistance of the arc.

In Example 19, the method of any one or more of Examples 15-18 optionally further includes that the event detection element is a capacitor.

In Example 20, the method of any one or more of Examples 15-19 optionally further includes coupling an over voltage suppressor between the wire terminals and in parallel with at least one of the event detection element and the current shunt element.

In Example 21, the method of any one or more of Examples 15-20 optionally further includes that the over voltage suppressor comprises a transient-voltage-suppression diode.

In Example 22, the method of any one or more of Examples 15-21 optionally further includes that the over voltage suppressor comprises a first element in parallel with the event detection element and in series with the current shunt element and a second element in parallel with the current shunt element and in series with the event detection element.

In Example 23, the method of any one or more of Examples 15-22 optionally further includes coupling a third wire terminal between the event detection element and the current shunt element.

In Example 24, the method of any one or more of Examples 15-23 optionally further includes that an electric potential of the third wire terminal is indicative of at least one of an arc ignition, contact separation, and a suppressed arc.

In Example 25, the method of any one or more of Examples 15-24 optionally further includes coupling the pair of wire terminals to at least one of a corresponding pair of switch contacts, a corresponding pair of electrodes, and a corresponding pair of connectors.

In Example 26, the method of any one or more of Examples 15-25 optionally further includes that the event detection element is directly coupled to a first one of the pair of wire terminals, and wherein the current shunt element is directly coupled to a second one of the pair of wire terminals, and wherein the event detection element is directly coupled to the current shunt element.

In Example 27, the method of any one or more of Examples 15-26 optionally further includes forming a housing, the pair of terminals positioned on the housing, the event detection element and the a non-linear current shunt element in series with the event detection element being positioned within the housing.

In Example 28, the method of any one or more of Examples 15-27 optionally further includes positioning the third terminal on the housing.

The above examples are non-limiting, and passive arc suppressors 100 can be developed according to the principles and topologies disclosed herein to meet specifications across a range of applications. Passive arc suppressors 100 as disclosed herein can be fabricated using a variety of technologies known in the art, including solid state, liquid and gaseous technologies. Passive arc suppressors 100 and related devices and systems can be scaled from small size to large size, low power to high power, low voltage to high voltage, and low current to high current. It is to be understood that the passive arc suppressor 100 examples disclosed herein can be carried out by different equipment and devices, and that various modifications, both as to the equipment and operating procedures, can be accomplished without departing from the scope of the passive arc suppressor itself.

The description of the various embodiments is merely exemplary in nature and, thus, variations that do not depart from the gist of the examples and detailed description herein are intended to be within the scope of the present disclosure. Such variations are not to be regarded as a departure from the spirit and scope of the present disclosure.

### ADDITIONAL NOTES

The above detailed description includes references to the accompanying drawings, which form a part of the detailed description. The drawings show, by way of illustration, specific embodiments. These embodiments are also referred to herein as “examples.” Such examples can include elements in addition to those shown and described. However, the present inventor also contemplates examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. In addition, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. An electrical circuit, comprising:
a pair of terminals; and
an arc suppressor coupled between the pair of terminals, the arc suppressor comprising:
an event detection element; and
a non-linear current shunt element in series with the event detection element.

2. The electrical circuit of claim 1, wherein the non-linear current shunt element is comprised of at least one of a solid positive temperature coefficient (PTC) material, a liquid PTC material, and a gaseous PTC material.

3. The electrical circuit of claim 2, wherein the non-linear current shunt element is a resettable fusing element.

4. The electrical circuit of claim 1, wherein, upon an ignition of an arc in parallel with the arc suppressor, the non-linear current shunt element has a resistance lower than an arc ignition resistance of the arc.

5. The electrical circuit of claim 1, wherein the event detection element comprises a capacitor.

6. The electrical circuit of claim 1, wherein the arc suppressor further comprises an over voltage suppressor coupled between the wire terminals and coupled in parallel with at least one of the event detection element and the current shunt element.

7. The electrical circuit of claim 6, wherein the over voltage suppressor comprises a transient-voltage-suppression diode.

8. The electrical circuit of claim 7, wherein the over voltage suppressor comprises a first element in parallel with the event detection element and in series with the current shunt element and a second element in parallel with the current shunt element and in series with the event detection element.

9. The electrical circuit of claim 1, further comprising a third wire terminal coupled between the event detection element and the current shunt element.

10. The electrical circuit of claim 9, wherein an electric potential of the third wire terminal is indicative of at least one of an arc ignition, contact separation, and a suppressed arc.

11. The electrical circuit of claim 1, wherein the pair of wire terminals are coupled to at least one of a corresponding pair of switch contacts, a corresponding pair of electrodes, and a corresponding pair of connectors.

12. The electrical circuit of claim 1, wherein the event detection element is directly coupled to a first one of the pair of wire terminals, and wherein the current shunt element is directly coupled to a second one of the pair of wire terminals, and wherein the event detection element is directly coupled to the current shunt element.

13. An arc suppression device, comprising:
a housing;
a pair of terminals positioned on the housing; and
an arc suppressor enclosed within the housing and coupled between the pair of terminals, the arc suppressor comprising:
a event detection element; and
a non-linear current shunt element in series with the event detection element.

14. The arc suppression device of claim 13, wherein the arc suppressor further includes a third terminal positioned on the housing and coupled between the event detection element and the current shunt element.

15. The arc suppression device of claim 14, wherein, upon an ignition of an arc in parallel with the arc suppressor, the non-linear current shunt element has a resistance lower than an arc ignition resistance of the arc.

16. The arc suppression device of claim 13, wherein the pair of terminals are configured to be coupled to at least one of a corresponding pair of switch contacts, a corresponding pair of electrodes, and a corresponding pair of connectors.

17. An arc suppressor, consisting essentially of:
an event detection element; and
a non-linear current shunt element in series with the event detection element.

18. The arc suppressor of claim 17, wherein the non-linear current shunt element is comprised of at least one of a solid positive temperature coefficient (PTC) material, a liquid PTC material, and a gaseous PTC material.

19. The arc suppressor of claim 18, wherein the non-linear current shunt element is a resettable fusing element.

20. The arc suppressor of claim 17, wherein, upon an ignition of an arc in parallel with the arc suppressor, the non-linear current shunt element has a resistance lower than an arc ignition resistance of the arc.

21. The arc suppressor of claim 17, wherein the event detection element comprises a capacitor.
